(19) United States
(12) Patent Application Publication
(10) Pub. No.: US 2022/0165252 A1
(43) Pub. Date: May 26, 2022

(54) UTTERANCE EVALUATION METHOD AND UTTERANCE EVALUATION DEVICE

(71) Applicant: PANASONIC INTELLECTUAL PROPERTY MANAGEMENT CO., LTD., Osaka (JP)

(72) Inventors: Akihiro TARUGUCHI, Fukuoka (JP); Ryota FUJII, Fukuoka (JP)

(73) Assignee: PANASONIC INTELLECTUAL PROPERTY MANAGEMENT CO., LTD., Osaka (JP)

(21) Appl. No.: 17/528,914

(22) Filed: Nov. 17, 2021

(30) Foreign Application Priority Data
Nov. 20, 2020 (JP) 2020-193370

(51) Int. Cl. G10L 15/01; G10L 15/22; G10L 15/06

(52) U.S. Cl. CPC G10L 15/01; G10L 2015/0636; G10L 15/063; G10L 15/22

(57) ABSTRACT

An utterance evaluation method evaluates an utterance of a speaker based on a plurality of evaluation items. The utterance evaluation method is performed by a terminal device. The utterance evaluation method includes acquiring utterance voice data of the speaker and a subjective evaluation result provided by a listener, learning a weighting factor corresponding to each of the plurality of evaluation items based on the subjective evaluation result so as to calculate a new weighting factor, and evaluating each of the plurality of evaluation items based on the utterance voice data and the calculated new weighting factor and outputting a comprehensive evaluation result of the utterance of the speaker.

### CROSS-REFERENCE TO RELATED APPLICATIONS

This application is based on and claims priority under 35 USC 119 from Japanese Patent Application No. 2020-193370 filed on Nov. 20, 2020, the contents of which are incorporated herein by reference.

### TECHNICAL FIELD

The present disclosure relates to an utterance evaluation method and an utterance evaluation device.

### BACKGROUND ART

JP-A-2015-197621 discloses a speaking manner evaluation device that evaluates a speaking manner of a speaker based on an input voice signal. A weighting factor for weighting each evaluation item (for example, regulation of utterance speed, intonation of utterance, clarity of utterance, and the like) is set in advance in the speaking manner evaluation device. The speaking manner evaluation device calculates, based on each evaluation value and the set weighting factor, any one of a regulation evaluation value that evaluates the regulation of the utterance speed, an intonation evaluation value that evaluates the intonation of the utterance, and a clarity evaluation value that evaluates the clarity of the utterance. The speaking manner evaluation device outputs the calculated value as a voice evaluation value, and calculates a total score of the input voice signal based on the voice evaluation value when two or more of the regulation evaluation value, the intonation evaluation value, and the clarity evaluation value are calculated.

In JP-A-2015-197621, a subjective evaluation experiment related to audibility is performed in advance by a plurality of subjects, and the speaking manner evaluation device determines and sets the weighting factor of each evaluation item based on an experimental result of the subjective evaluation experiment. However, when there is a difference between a speaking manner an actual listener (for example, a customer) requests a speaker (for example, an operator of a call center) to speak in (that is, an evaluation item that is considered to be important for the actual listener among evaluation items) and the weighting factor of each evaluation item set based on the subjective evaluation experiment at the time of actual operation, there may be a difference between a subjective evaluation (satisfaction level) provided by the actual listener and the total score of the speaker (for example, the operator) calculated by the speaking manner evaluation device. It is preferable to evaluate the speaking manner of the speaker while the subjective evaluation of the actual listener is reflected. However, in such a case, the listener is required to respond to a plurality of subjective evaluations corresponding to the respective evaluation items after telephone answering, which is considerably troublesome.

### SUMMARY OF INVENTION

The present disclosure has been made in view of the above-described circumstances, and aspect of non-limiting embodiments of the present disclosure relates to provide an utterance evaluation method and an utterance evaluation device capable of further improving evaluation accuracy of an utterance evaluation and supporting utterance education for a speaker.

According to an aspect of the present disclosure, there is provided an utterance evaluation method that evaluates an utterance of a speaker based on a plurality of evaluation items, the utterance evaluation method being performed by a terminal device and including:

acquiring utterance voice data of the speaker and a subjective evaluation result provided by a listener;

learning a weighting factor corresponding to each of the plurality of evaluation items based on the subjective evaluation result so as to calculate a new weighting factor; and

evaluating each of the plurality of evaluation items based on the utterance voice data and the calculated new weighting factor and outputting a comprehensive evaluation result of the utterance of the speaker.

According to an another aspect of the present disclosure, there is also provided an utterance evaluation device including:

an acquisition unit configured to acquire utterance voice data of a speaker and a subjective evaluation result provided by a listener;

a calculation unit configured to learn a weighting factor corresponding to each of a plurality of evaluation items based on the subjective evaluation result so as to calculate a new weighting factor; and

an output unit configured to evaluate each of the plurality of evaluation items based on the utterance voice data and the calculated new weighting factor and to output a comprehensive evaluation result of an utterance of the speaker.

According to the aspects of the present disclosure, the evaluation accuracy of the utterance evaluation can be further improved, and the utterance education for the speaker can be supported.

### BRIEF DESCRIPTION OF DRAWINGS

FIG. 1 is a block diagram showing an example of an internal configuration of a terminal device according to an embodiment;

FIG. 2 is a flowchart showing an example of an operation procedure of the terminal device according to the embodiment;

FIG. 3 is a flowchart showing an example of an operator voice analysis processing procedure of the terminal device according to the embodiment;

FIG. 4 is a flowchart showing an example of an evaluation procedure of an evaluation item “voice brightness” and an evaluation item “intonation” of the terminal device according to the embodiment;

FIG. 5 is a flowchart showing an example of an evaluation procedure of an evaluation item “voice volume” and an evaluation item “speech rate” of the terminal device according to the embodiment;

FIG. 6 is a flowchart showing an example of an evaluation procedure of an evaluation item “articulation” of the terminal device according to the embodiment;

FIG. 7 is a flowchart showing an example of a weighting factor update processing procedure of the terminal device according to the embodiment;

FIG. 8 shows an example of a speaking manner improvement point screen.

### DESCRIPTION OF EMBODIMENTS

Hereinafter, an embodiment that specifically discloses configurations and operations of an utterance evaluation method and an utterance evaluation device according to the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

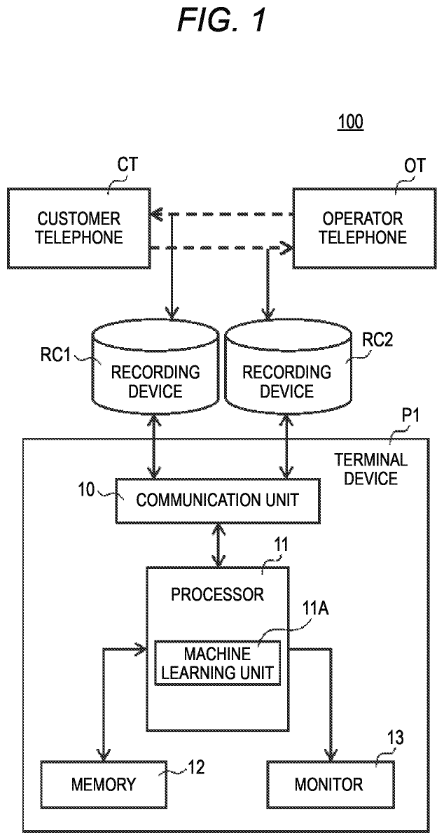

First, a terminal device P1 that serves as an example of the utterance evaluation device will be described with reference to FIG. 1. FIG. 1 is a block diagram showing an example of an internal configuration of the terminal device P1 according to the embodiment. An example in which the terminal device P1 shown in FIG. 1 performs an utterance evaluation of one operator based on utterance voice data of the operator (for example, an operator of a call center) serving as one speaker and utterance voice data of a customer serving as one listener will be described. However, the number of operators whose utterance is evaluated by the terminal device P1 is not limited to one, and it is needless to say that utterance evaluations of two or more operators may be performed.

An operator telephone OT is a telephone such as a public telephone, a fixed telephone, a mobile wireless telephone such as a smartphone or a tablet terminal, a cordless telephone, or a personal computer (PC) having a function of enabling a voice call between the operator and the customer, and is used by the operator. The operator telephone OT converts voice of the operator into a voice signal, and transmits the converted voice signal of the operator to a customer telephone CT. The operator telephone OT also converts a voice signal transmitted from the customer telephone CT used by the customer into voice and outputs the voice. The operator telephone OT may also have a voice recording function of recording and storing the voice uttered by the operator. In a case where the operator telephone OT is implemented by, for example, a smartphone, a tablet terminal, a PC, or the like, the operator telephone OT may be configured integrally with the terminal device P1, and may be capable of achieving the voice recording function and an utterance evaluation function performed by the terminal device P1 to be described later.

The customer telephone CT is a telephone such as a public telephone, a fixed telephone, a mobile wireless telephone such as a smartphone or a tablet terminal, a cordless telephone, or a PC having a function of enabling a voice call between the operator and the customer, and is used by the customer. The customer telephone CT converts voice of the customer and an output signal (that is, a push signal) obtained by a push operation for inputting a subjective evaluation of the customer into a voice signal, and transmits the voice signal of the converted voice of the customer and the output signal (that is, a subjective evaluation result of the customer) obtained by the push operation to the operator telephone OT. The customer telephone CT also converts the voice signal transmitted from the operator telephone OT used by the operator into voice and outputs the voice. After the call between the operator and the customer is ended, the customer telephone CT receives an input of a subjective evaluation (for example, score, grade evaluation, or the like) related to utterance of the operator input by a push operation of the customer.

When both the operator telephone OT and the customer telephone CT are PCs, smartphones or tablet terminals, the customer telephone CT may receive the input of the subjective evaluation of the customer by using a user interface constituted by using, for example, a mouse, a keyboard, a touch panel, or the like. In such a case, the customer telephone CT transmits the subjective evaluation result input by the customer to the operator telephone OT.

A recording device RC1 is, for example, a storage medium such as a hard disk drive (HDD) or an SD card (registered trademark), and records the voice of the operator. Although the recording device RC1 is formed separately from a recording device RC2 in the example shown in FIG. 1, the recording device RC1 may be formed integrally with the recording device RC2. Although the recording device RC1 is formed separately from the terminal device P1 in the example shown in FIG. 1, the recording device RC1 may be formed integrally with the terminal device P 1. The recording device RC1 transmits the recorded utterance voice data (that is, the voice signal) of the operator to the terminal device P1. In addition, the recording device RC1 may be capable of recording voice of not only the operator telephone OT but also one or more other telephones (not shown) used by a plurality of operators.

The recording device RC2 is, for example, a storage medium such as an HDD or an SD card (registered trademark). The registered trademark RC2 converts the voice of the customer and the output signal obtained by the input operation (push operation) of subjective evaluation of the customer into a voice signal and records the voice signal. Although the recording device RC2 is formed separately from the recording device RC1 in the example shown in FIG. 1, the recording device RC2 may be formed integrally with the recording device RC1. Although the recording device RC2 is formed separately from the terminal device P1 in the example shown in FIG. 1, the recording device RC2 may be formed integrally with the terminal device P1. The recording device RC2 transmits the recorded utterance voice data (that is, the voice signal) to the terminal device P1.

The terminal device P1 is, for example, a PC, a smartphone, a tablet terminal, or the like, and performs the utterance evaluation of the operator. The terminal device P1 acquires the utterance voice data of the operator transmitted from the recording device RC1 and the utterance voice data including the subjective evaluation result of the customer transmitted from the recording device RC2, and performs the utterance evaluation of the operator. The terminal device P1 outputs a result of the utterance evaluation of the operator (hereinafter, referred to as the “comprehensive evaluation result”) to a monitor 13. The terminal device P1 includes a communication unit 10, a processor 11, a memory 12, and the monitor 13.

The communication unit 10 that serves as an example of an acquisition unit is connected between the recording devices RC1 and RC2 so as to enable data communication therebetween, and is constituted by using a communication interface circuit configured to transmit and receive data or information to and from each of the recording devices RC1 and RC2. The communication unit 10 outputs the utterance voice data of the operator transmitted from the recording device RC1 and the utterance voice data including the subjective evaluation result of the customer transmitted from the recording device RC2 to the processor 11.

The processor 11 that serves as an example of a calculation unit and an output unit is constituted by using, for example, a central processing unit (CPU) or a field programmable gate array (FPGA), and performs various types of processing and control in cooperation with the memory 12. Specifically, the processor 11 implements functions of each unit by referring to programs and data held in the memory 12 and executing the programs.

A machine learning unit 11A learns a weighting factor used to evaluate each of a plurality of evaluation items for performing the utterance evaluation of the operator, and generates learning data related to the weighting factor corresponding to each evaluation item. The learning for generating the learning data may be performed by using one or more statistical classification techniques. Examples of the statistical classification techniques include linear classifiers, support vector machines, quadratic classifiers, kernel estimation, decision trees, artificial neural networks, Bayesian techniques and/or networks, hidden Markov models, binary classifiers, multi-class classifiers, a clustering technique, a random forest technique, a logistic regression technique, a linear regression technique, a gradient boosting technique, and the like. However, the statistical classification techniques to be used are not limited thereto.

The memory 12 includes a storage device that has: a semiconductor memory constituted by a random access memory (RAM) and a read only memory (ROM); and any one storage device constituted by a solid state drive (SSD) or an HDD. In addition, the memory 12 stores various types of data that enable voice recognition, such as learning data, an acoustic model, a pronunciation dictionary, a language model, and a recognition decoder, a learning model for learning (calculating) the weighting factor, a target value set in accordance with each evaluation item, information on a comprehensive evaluation value of the operator calculated in the past, and the like.

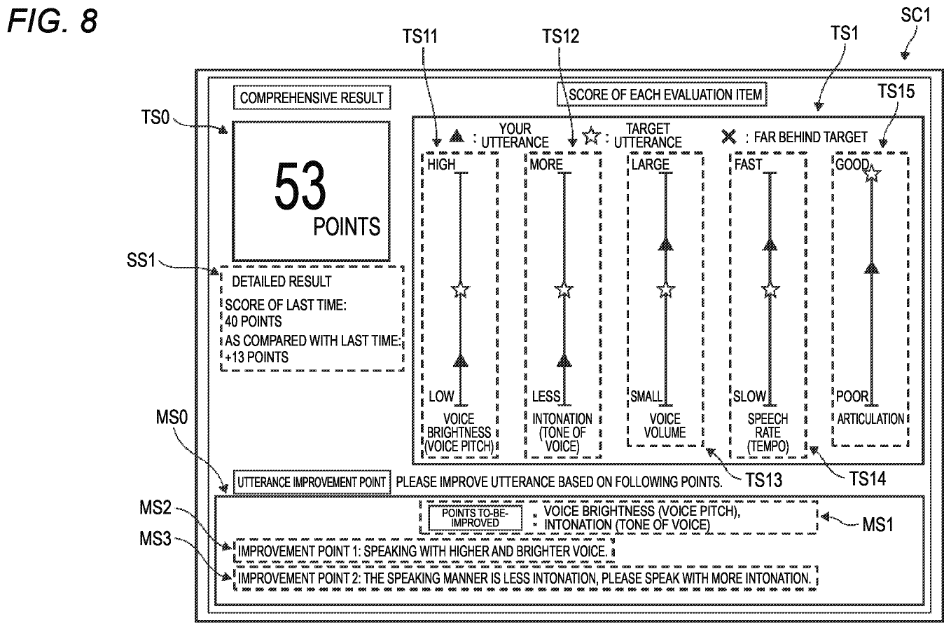

The monitor 13 is constituted by using, for example, a liquid crystal display (LCD) or an organic electroluminescence (EL) display. The monitor 13 displays a speaking manner improvement point screen (see FIG. 8) based on the comprehensive evaluation result of the operator output from the processor 11.

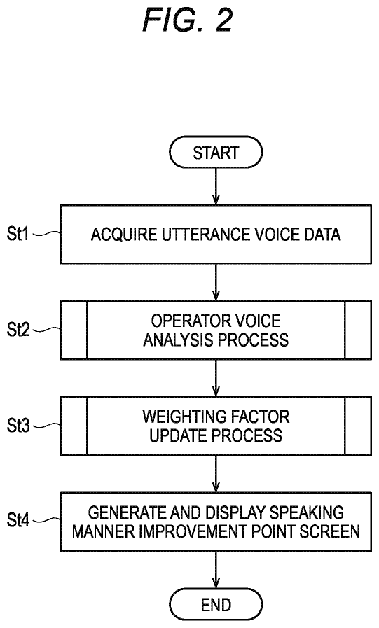

Next, an operation procedure of the terminal device P1 according to the embodiment will be described with reference to FIG. 2. FIG. 2 is a flowchart showing an example of an operation procedure of the terminal device P1 according to the embodiment.

The processor 11 acquires the utterance voice data (voice signal) of the operator transmitted from the recording device RC1 and the utterance voice data (voice signal) including the subjective evaluation result of the customer transmitted from the recording device RC2 as a response record of the operator in response to the customer (St1).

The processor 11 performs a voice analysis process of the operator (that is, a speaker) based on the acquired utterance voice data of the operator and the weighting factor (learning data) corresponding to each evaluation item stored in the memory 12 (St2), and performs the utterance evaluation of the operator.

The processor 11 performs a weighting factor update process based on the comprehensive evaluation result of the operator generated in the process of step St2 and the subjective evaluation result of the customer (St3).

The processor 11 generates the speaking manner improvement point screen (see FIG. 8) based on the comprehensive evaluation result related to utterance of the operator, and outputs and displays the screen on the monitor 13 (St4).

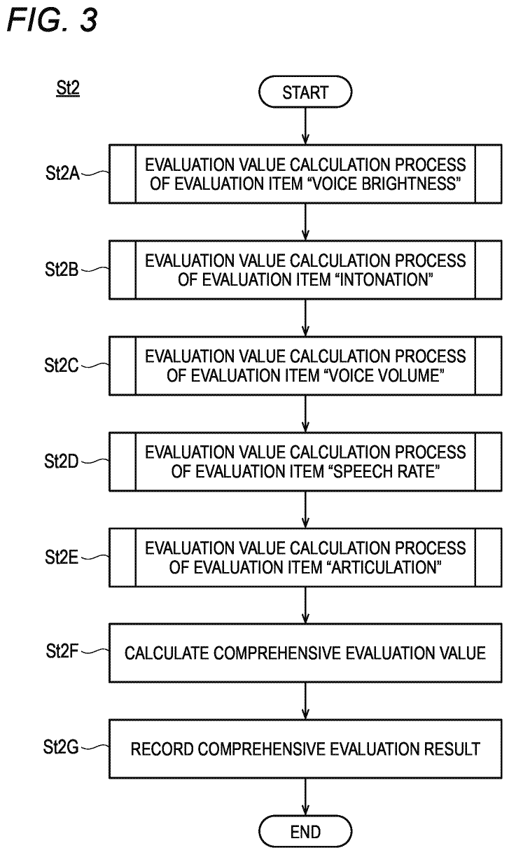

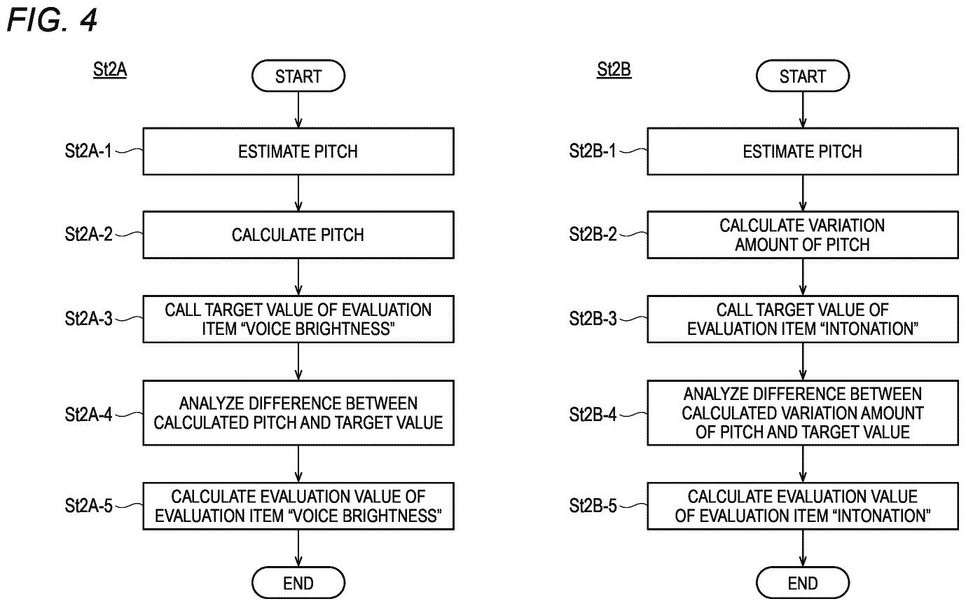

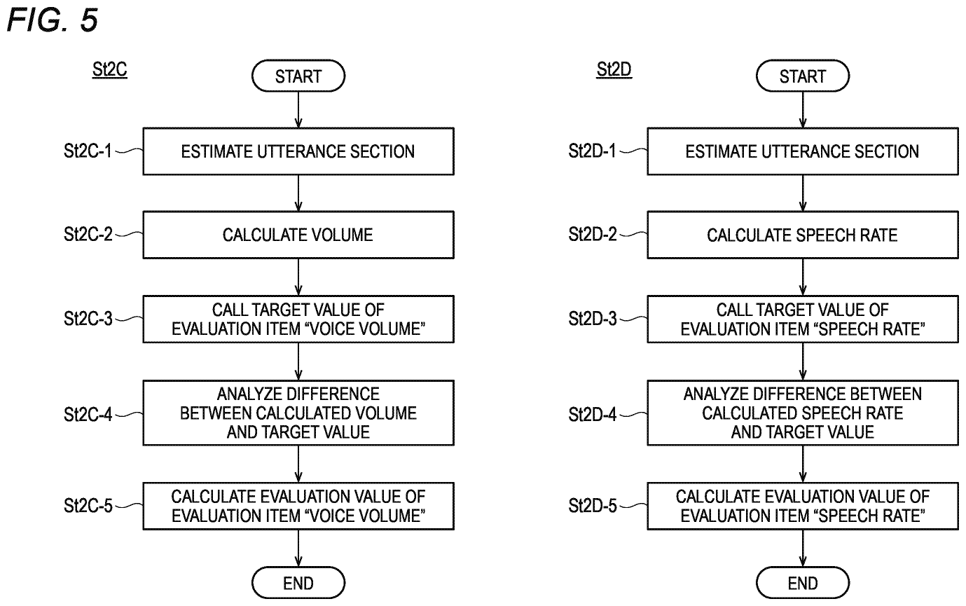

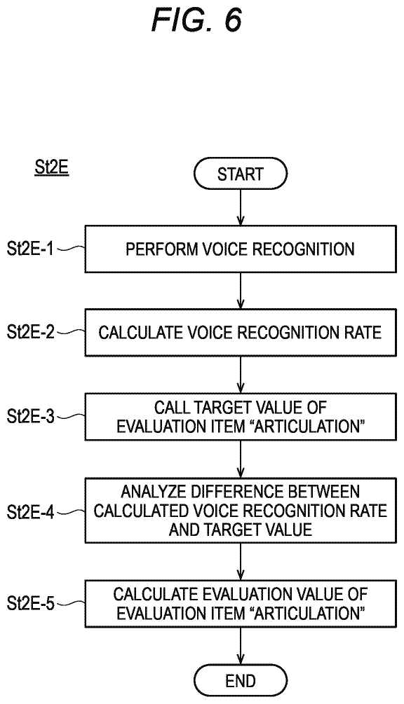

Here, the voice analysis process of the operator (speaker) performed by the processor 11 of the terminal device P1 will be described with reference to FIGS. 3 to 6. FIG. 3 is a flowchart showing an example of an operator voice analysis processing procedure of the terminal device P1 according to the embodiment. FIG. 4 is a flowchart showing an example of an evaluation procedure of an evaluation item “voice brightness” and an evaluation item “intonation” of the terminal device P1 according to the embodiment. FIG. 5 is a flowchart showing an example of an evaluation procedure of an evaluation item “voice volume” and an evaluation item “speech rate” of the terminal device P1 according to the embodiment. FIG. 6 is a flowchart showing an example of an evaluation procedure of an evaluation item “articulation” of the terminal device P1 according to the embodiment. Each of the five evaluation items shown in FIGS. 3 to 6 is an example, and the present invention is not limited thereto. The number of evaluation items is not limited to five, and may be, for example, four or less, or six or more.

First, an evaluation value calculation procedure of the evaluation item “voice brightness” performed by the processor 11 will be described. The processor 11 performs an evaluation value calculation process of the evaluation item “voice brightness” among the five evaluation items based on the utterance voice data (voice signal) of the operator (St2A).

The processor 11 converts the utterance voice data (voice signal) of the operator into a frequency spectrum, and estimates a pitch (voice height) of voice of the operator based on the converted frequency spectrum (St2A-1). It should be noted that a known technique may be used as a pitch estimation method performed here. The processor 11 calculates the pitch of the operator (that is, the voice brightness) based on the estimated pitch (St2A-2). The processor 11 refers to the memory 12, calls a target value for evaluating the evaluation item “voice brightness” set in advance (St2A-3), and analyzes a difference between the calculated pitch and the target value (St2A-4). The processor 11 calculates an evaluation value of the evaluation item “voice brightness” based on the difference between the calculated pitch and the target value (St2A-5).

Next, an evaluation value calculation procedure of the evaluation item “intonation” performed by the processor 11 will be described. The processor 11 performs an evaluation value calculation process of the evaluation item “intonation” among the five evaluation items based on the utterance voice data (voice signal) of the operator (St2B).

The processor 11 converts the utterance voice data (voice signal) of the operator into the frequency spectrum, and estimates the pitch of the voice (tone of voice) of the operator based on the converted frequency spectrum (St2B-1). It should be noted that a known technique may be used as the pitch estimation method performed here. The processor 11 calculates a variation amount of the pitch of the voice of the operator (that is, the voice brightness) based on the estimated pitch (St2B-2). The processor 11 refers to the memory 12, calls a target value for evaluating the evaluation item “intonation” set in advance (St2B-3), and analyzes a difference between the calculated variation amount of the pitch and the target value (St2B-4). The processor 11 calculates an evaluation value of the evaluation item “intonation” based on the difference between the calculated variation amount of the pitch and the target value (St2B-5).

Next, an evaluation value calculation procedure of the evaluation item “voice volume” performed by the processor 11 will be described. The processor 11 performs an evaluation value calculation process of the evaluation item “voice volume” among the five evaluation items based on the utterance voice data (voice signal) of the operator (St2C).

The processor 11 estimates an utterance section where the operator utters based on the utterance voice data (voice signal) of the operator (St2C-1). The processor 11 calculates volume of the operator (that is, the voice volume) based on estimated magnitude of the voice signal of each utterance section (St2C-2). It should be noted that a known technique may be used as an utterance section estimation method performed here. The processor 11 refers to the memory 12, calls a target value for evaluating the evaluation item “voice volume” set in advance (St2C-3), and analyzes a difference between the calculated voice volume and the target value (St2C-4). The processor 11 calculates an evaluation value of the evaluation item “voice volume” based on the difference between the calculated voice volume and the target value (St2C-5).

Next, an evaluation value calculation procedure of the evaluation item “speech rate” performed by the processor 11 will be described. The processor 11 performs an evaluation value calculation process of the evaluation item “speech rate” among the five evaluation items based on the utterance voice data (voice signal) of the operator (St2D).

The processor 11 estimates the utterance section where the operator utters based on the utterance voice data (voice signal) of the operator (St2D-1). The processor 11 performs mora analysis, utterance amount analysis using voice recognition, formant-frequency-based voice analysis, or the like based on the estimated voice signal of each utterance section, and calculates an utterance amount per predetermined time (that is, the speech rate) (St2D-2). It should be noted that known techniques may be used as an utterance section estimation method and an utterance amount analysis method performed here. The processor 11 refers to the memory 12, calls a target value for evaluating the evaluation item “speech rate” set in advance (St2D-3), and analyzes a difference between the calculated speech rate and the target value (St2D-4). The processor 11 calculates an evaluation value of the evaluation item “speech rate” based on the difference between the calculated speech rate and the target value (St2D-5).

Next, an evaluation value calculation procedure of the evaluation item “articulation” performed by the processor 11 will be described. The processor 11 performs an evaluation value calculation process of the evaluation item “articulation” among the five evaluation items based on the utterance voice data (voice signal) of the operator (St2E).

The processor 11 performs voice recognition based on the utterance voice data (voice signal) of the operator (St2E-1). The processor 11 calculates a voice recognition rate based on a result of the voice recognition (St2E-2). It should be noted that known techniques may be used as a voice recognition method and a voice recognition rate calculation method performed here. The processor 11 refers to the memory 12, calls a target value for evaluating the evaluation item “articulation” set in advance (St2E-3), and analyzes a difference between the calculated voice recognition rate and the target value (St2E-4). The processor 11 calculates an evaluation value of the evaluation item “articulation” based on the difference between the calculated voice recognition rate and the target value (St2E-5).

The processor 11 calculates a comprehensive evaluation value related to the utterance of the operator based on the evaluation values of all the evaluation items and latest weighting factors w₁, w₂, w₃, w₄, and w₅ (St2F).

Here, the weighting factor w₁ is a factor for weighting that is set for the evaluation value of the evaluation item “voice brightness”. The weighting factor w₂ is a factor for weighting that is set for the evaluation value of the evaluation item “intonation”. The weighting factor w₃ is a factor for weighting that is set for the evaluation value of the evaluation item “voice volume”. The weighting factor w₄ is a factor for weighting that is set for the evaluation value of the evaluation item “speech rate”. The weighting factor w₅ is a factor for weighting that is set for the evaluation value of the evaluation item “articulation”.

The comprehensive evaluation value is calculated by (evaluation value of evaluation item “voice brightness”)×w₁+(evaluation value of evaluation item “intonation”)×w₂+(evaluation value of evaluation item “voice volume”)×w₃+(evaluation value of evaluation item “speech rate”)×w₄+(evaluation value of evaluation item “articulation”)×w₅.

The processor 11 generates a comprehensive evaluation result based on the calculated comprehensive evaluation value of the operator, and records the comprehensive evaluation result in the memory 12 for each operator (St2G). Specifically, the processor 11 generates a comprehensive evaluation result including the evaluation values of the evaluation items calculated in the respective processes of steps St2A-5, St2B-5, St2C-5, St2D-5, and St2E-5, and a relative value of the comprehensive evaluation value obtained by dividing the calculated comprehensive evaluation value by a maximum value of the comprehensive evaluation value calculated based on the respective values of the latest weighting factors w₁ to w₅, and records the comprehensive evaluation result for each operator.

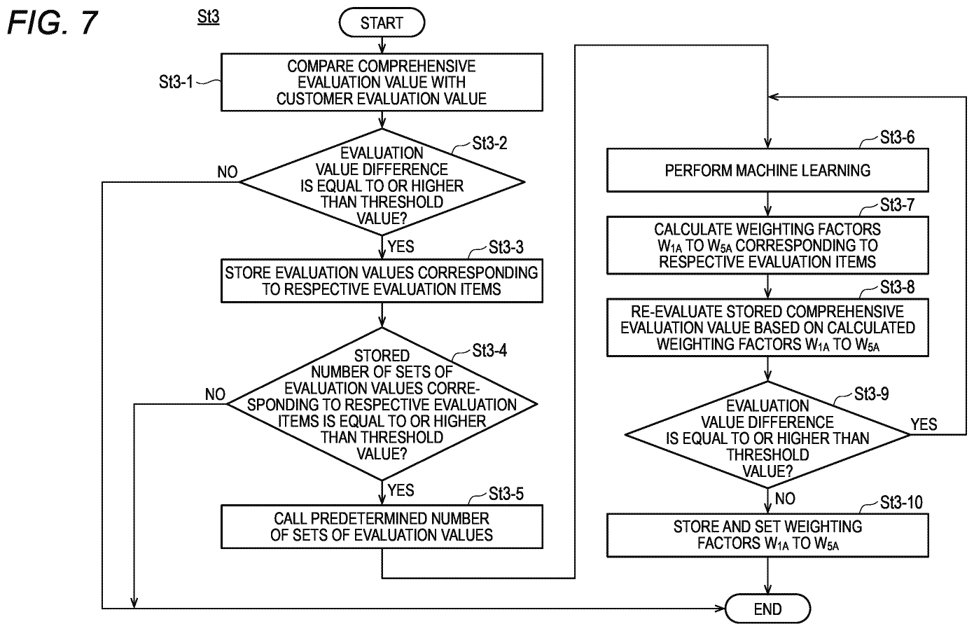

The weighting factor update process performed by the processor 11 of the terminal device P1 in step St3 shown in FIG. 2 will be described with reference to FIG. 7. FIG. 7 is a flowchart showing an example of a weighting factor update processing procedure of the terminal device P1 according to the embodiment.

The processor 11 compares the comprehensive evaluation value related to the utterance of the operator calculated in the process of step St2F with a customer evaluation value that serves as the subjective evaluation result of the customer (St3-1). As a result of the comparison, the processor 11 determines whether a difference between the comprehensive evaluation value and the customer evaluation value is equal to or higher than a preset threshold value (St3-2).

When it is determined that the difference between the comprehensive evaluation value and the customer evaluation value is equal to or higher than the preset threshold value as a result of the process of step St3-3 (St3-2, YES), the processor 11 stores each of the evaluation values of the evaluation items used in the process of calculating the comprehensive evaluation value causing the determination that the difference between the comprehensive evaluation value and the customer evaluation value is equal to or higher than the threshold value (that is, the five evaluation values including the evaluation value of the evaluation item “voice brightness”, the evaluation value of the evaluation item “intonation”, the evaluation value of the evaluation item “voice volume”, the evaluation value of the evaluation item “speech rate”, and the evaluation value of the evaluation item “articulation”) in the memory 12 (St3-3). On the other hand, when it is determined that the difference between the comprehensive evaluation value and the customer evaluation value is not equal to or higher than the preset threshold value as a result of the process of step St3-3 (St3-2, NO), the processor 11 omits the weighting factor update process and proceeds to the process of step St4.

The processor 11 refers to the memory 12 and determines whether the number of sets of the evaluation values of the respective evaluation items used for the calculation of the comprehensive evaluation value causing the determination that the difference between the comprehensive evaluation value and the customer evaluation value is equal to or higher than the threshold value stored in the memory 12 is equal to or higher than a predetermined number (St3-4). Specifically, the processor 11 counts the evaluation values of the respective evaluation items as one set. For example, when the predetermined number is five, the processor 11 determines whether there are five sets of evaluation values of the respective evaluation items storing in the memory 12. In addition, the predetermined number herein is a number by which each of the new weighting factors w₁ to w₅ can be calculated (updated). The predetermined number preferably has a value equal to the number of evaluation items (that is, five in the example shown in the present embodiment), but is not limited thereto, and may also be set to have a value that is less or more than the number of evaluation items.

When it is determined that the number of sets of the evaluation values of the respective evaluation items stored in the memory 12 is equal to or higher than the predetermined number in the process of step St3-4 (St3-4, YES), the processor 11 calls the predetermined number of sets of the evaluation values of the evaluation items stored in the memory 12 (St3-5). On the other hand, when it is determined that the number of sets of the evaluation values of the respective evaluation items stored in the memory 12 is not equal to or higher than the predetermined number in the process of step St3-4 (St3-4, NO), the processor 11 determines that it is not possible to calculate (update) each of the weighting factors w₁ to w₅, omits the weighting factor update process, and proceeds to the process of step St4.

The processor 11 performs machine learning based on the called predetermined number of sets of the evaluation values of the respective evaluation items (St3-6), and calculates new weighting factors w_{1A} to w_{5A} that cause the difference between the comprehensive evaluation value calculated by using each of the weighting factors w₁ to w₅ and the customer evaluation value (that is, the subjective evaluation result of the customer) to be equal to or lower than the threshold value based on the predetermined number of sets of the evaluation values of the respective evaluation items (St3-7). The processor 11 re-calculates (re-evaluates) the comprehensive evaluation value based on each of the calculated new weighting factors w_{1A} to w_{5A} (St3-8), and re-determines whether the difference between the comprehensive evaluation value and the customer evaluation value is equal to or higher than the preset threshold value (St3-9).

When it is determined that the difference between the comprehensive evaluation value and the customer evaluation value is equal to or higher than the preset threshold value as a result of the process of step St3-9 (St3-9, YES), the processor 11 returns to the process of step St3-6 and re-performs the machine learning. On the other hand, when it is determined that the difference between the comprehensive evaluation value and the customer evaluation value is not equal to or higher than the preset threshold value as a result of the process of step St3-9 (St3-9, NO), the processor 11 sets the new weighting factors w_{1A} to w_{5A} and stores the new weighting factors w_{1A} to w_{5A} in the memory 12 (St3-10).

As described above, the terminal device P1 according to the embodiment learns the weighting factors based on the customer evaluation value (subjective evaluation) of the actual customer, and can calculate and set (update) each of the new weighting factors w_{1A} to w_{5A}, so that an increase in the difference between the customer evaluation value (subjective evaluation) of the actual customer and the comprehensive evaluation value calculated by the terminal device P1 can be more efficiently prevented, and thus an utterance evaluation of the operator, in which the subjective evaluation of the actual customer is reflected, can be performed. That is, the terminal device P1 can further improve evaluation accuracy of the utterance evaluation of the operator. In addition, since the terminal device P1 can perform the utterance evaluation of the operator, in which the subjective evaluation of the actual customer is reflected, by acquiring the subjective evaluation result of at least one customer, time and effort for inputting the subjective evaluation by the customer can be further saved.

Next, a speaking manner improvement point screen SC1 generated by the processor 11 of the terminal device P1 will be described with reference to FIG. 8. FIG. 8 shows an example of the speaking manner improvement point screen SC1. It is needless to say that the speaking manner improvement point screen SC1 shown in FIG. 8 is an example, and the present invention is not limited thereto.

The speaking manner improvement point screen SC1 including a comprehensive evaluation value display field TS0, an evaluation result display field TS1, an advice field MS0, and a result detail field SS1 is generated.

The comprehensive evaluation value display field TS0 shows the comprehensive evaluation value calculated based on the latest weighting factors w₁ to w₅. In the example shown in FIG. 8, for example, the comprehensive evaluation value of the operator is calculated as a score, and a score “53 points” is displayed. The comprehensive evaluation value shown in FIG. 8 may also be expressed by, for example, a percentage, or a symbol, a character, a numeral, or the like indicating a predetermined evaluation such as S, A, or B other than the score.

The evaluation result display field TS1 indicates a difference between each evaluation value of each evaluation item of the operator and the target value. For example, in evaluation results TS11, TS12, TS13, TS14, and TS15 corresponding to each evaluation item shown in FIG. 8, the target value of each evaluation item is indicated by “⋆”, and the evaluation value of each evaluation item is indicated by “Δ”. The evaluation result TS11 indicates a difference between the evaluation value and the target value related to the evaluation item “voice brightness”. The evaluation result TS12 indicates a difference between the evaluation value and the target value related to the evaluation item “intonation”. The evaluation result TS13 indicates a difference between the evaluation value and the target value related to the evaluation item “voice volume”. The evaluation result TS14 indicates a difference between the evaluation value and the target value related to the evaluation item “speech rate”. The evaluation result TS15 indicates a difference between the evaluation value and the target value related to the evaluation item “articulation”. Although not shown in the example shown in FIG. 8, when it is determined that there is a predetermined or more difference between the evaluation value and the target value, the processor 11 may indicate the evaluation value of the evaluation item determined to have the predetermined or more difference by “x”. As a result, the terminal device P1 can visualize and present the difference between the evaluation value and the target value of each determination item for the operator. Therefore, the operator can intuitively understand evaluation items for which the speaking manner is required to be improved.

The advice field MS0 indicates advice information that is generated based on the difference between the evaluation value of each evaluation item and the target value for improving the speaking manner of the operator, and includes a point-to-be-improved message MS1 and improvement point messages MS2 and MS3 as the advice information. Although the number of improvement point messages shown in FIG. 8 is two, the number of improvement point messages may be one or more. Specifically, based on the difference between each evaluation value of each evaluation item of the operator and the target value, the processor 11 generates the advice information for improving the speaking manner for one or more evaluation items having larger differences, and generates the advice field MS0 that includes the advice information.

In the example shown in FIG. 8, the processor 11 determines that the difference between the evaluation value and the target value is large in each of the two evaluation items including the evaluation item “voice brightness” and the evaluation item “intonation”, and generates the point-to-be-improved message MS1 of “point-to-be-improved: voice brightness (voice pitch), intonation (tone of voice)” that indicates two determination items determined to have the large difference. In addition, the processor 11 generates the improvement point message MS2 of “improvement point 1: speaking with higher and brighter voice” as the advice information on the determination item “voice brightness”, and the improvement point message MS3 of “improvement point 2: the speaking manner is less intonation, please speak with more intonation” as the advice information on the determination item “intonation”. As a result, the terminal device P1 can present the advice information necessary for increasing the evaluation value of each determination item to the operator, and thus can support improvement of the speaking manner of the operator.

The result detail field SS1 shows a previous comprehensive evaluation value (that is, a comprehensive evaluation value calculated last time before the current comprehensive evaluation value displayed in the comprehensive evaluation value display field TS0) and an evaluation value difference between the previous comprehensive evaluation value and the current comprehensive evaluation value (that is, as compared with the previous time). Specifically, the processor 11 calls the previous (last time) comprehensive evaluation value (score) of the operator from the memory 12, and generates the result detail field SS1 that includes: “previous score: 40 points” that includes information on the called previous comprehensive evaluation value; and “as compared with the previous time: +13 points” that includes information on the calculated evaluation value difference obtained by calculating a difference between the previous (last time) comprehensive evaluation value (score) of the operator and the current comprehensive evaluation value. As a result, the terminal device P1 can present a change in the comprehensive evaluation value of the operator to the operator.

As described above, the terminal device P1 according to the embodiment presents the comprehensive evaluation value, the difference between the evaluation value of each evaluation item and the target value, the evaluation item to be improved by the operator, an improvement method (advice information), and the like to the operator on the speaking manner improvement point screen SC1, and thus can support utterance education of the operator.

Here, the comprehensive evaluation value and the customer evaluation value (subjective evaluation) are supplemented. As described above, the evaluation values, the weighting factors, or the comprehensive evaluation values calculated therefrom for the plurality of evaluation items are used for evaluation, improvement, education, and the like of the operator. Therefore, in order to finely analyze response of the operator to the customer, it is preferable to calculate the comprehensive evaluation value by a complicated method. For example, improvement points of the operator can be extracted by a multifaceted evaluation of a plurality of items (five items in the example shown in the present embodiment) as described above. In addition, by calculating the comprehensive evaluation value and/or the evaluation value of each item with fine rating (in the example shown in the present embodiment, a full point of the comprehensive evaluation value is 100 points, and a full point of the evaluation value of each item is 20 points), superiority and inferiority of the operator can be finely evaluated.

Meanwhile, in general, the customer has a conversation with the operator in order to make certain inquiries, and is not intended to improve the operator. That is, it is difficult to obtain a detailed and accurate evaluation of the operator from such a customer. In addition, if the customer is requested to perform a fine evaluation for evaluating the operator, there is a concern that the customer cannot perform the evaluation operation since time and effort are required, and thus a probability of obtaining the evaluation value is decreased. Therefore, it is preferable that the customer evaluation value is calculated by a simple method as compared with the comprehensive evaluation value, for example. For example, the number of evaluation items for which the customer evaluation value is calculated (one in the example shown in the present embodiment) may be plural, but is preferably minimized. For this reason, as in the present embodiment, the number of evaluation items for which the customer evaluation value is calculated is less than the number of evaluation items for which the comprehensive evaluation value is calculated. In addition, when requesting the customer evaluation value from the customer, questions to the customer are not aimed to evaluate specific items related to the voice uttered by the operator, such as “voice brightness”, “intonation”, “voice volume”, “speech rate”, and “articulation”, but to make highly abstract questions related to an overall impression of the operator, such as “whether response of the operator is favorable” and “whether a degree of satisfaction relative to the response of the operator is high”, from the viewpoint of ease of answering by the customer. The questions or messages for requesting the customer to perform the subjective evaluation may be made to the customer telephone CT by automatic voice or the like, may be displayed on a display of the customer telephone CT, or may be directly transmitted to the customer by the operator. In addition, it is preferable that the customer evaluation value is calculated by rough rating (for example, five-grade evaluation) from the viewpoint of ease of answering by the customer.

In a case where rating forms (fineness, grain size, and the like) of the evaluation values of the comprehensive evaluation and the customer evaluation are different from each other, when the comprehensive evaluation result and the customer evaluation result are compared with each other in step St3-1 described above, the rating forms may be aligned with the same rating form. For example, conversion may be performed to align with any one of the rating forms (for example, conversion from 100-point-full-point to 5-point-full-point, or conversion from 5-point-full-point to 100-point-full-point), or each of the rating forms may be converted to a third rating form (for example, conversion from 100-point-full-point and 5-point-full-point to 10-point-full-point). As a result, the terminal device P1 can easily determine whether a difference in a result of a comparison between the comprehensive evaluation result and the customer evaluation result is equal to or higher than the threshold value. As described above, the terminal device P1 according to the present embodiment analyzes the plurality of evaluation items related to the voice uttered by the operator so as to calculate the comprehensive evaluation result of the operator, and updates the method of calculating the comprehensive evaluation result (that is, updates the weighting factor) by using the customer evaluation result derived based on subjectivity of the customer from the viewpoint of the difference in the evaluation items related to the voice as described above, so that the utterance evaluation of the operator, in which the subjective evaluation of the actual customer is reflected, can be performed.

As described above, the terminal device P1 according to the embodiment evaluates the speaker based on the plurality of evaluation items. The terminal device P1 acquires the utterance voice data of the speaker and at least one subjective evaluation result provided by the listener, learns the weighting factor corresponding to each of the plurality of evaluation items based on the subjective evaluation result so as to calculate the new weighting factors w_{1A} to w_{5A}, evaluates each of the plurality of evaluation items based on the utterance voice data and the calculated new weighting factors w_{1A} to w_{5A} and outputs the comprehensive evaluation result of the speaker.

As a result, the terminal device P1 according to the embodiment learns the weighting factors based on the customer evaluation value (subjective evaluation) of the actual customer, and can calculate and set (update) each of the new weighting factors w_{1A} to w_{5A}, so that the increase in the difference between the customer evaluation value (subjective evaluation) of the actual customer and the comprehensive evaluation value calculated by the terminal device P1 can be more efficiently prevented, and thus the utterance evaluation of the operator, in which the subjective evaluation of the actual customer is reflected, can be performed. That is, the terminal device P1 can further improve the evaluation accuracy of the utterance evaluation of the operator. In addition, since the terminal device P1 can perform the utterance evaluation of the operator, in which the subjective evaluation of the actual customer is reflected, by acquiring the subjective evaluation result of at least one customer, time and effort for inputting the subjective evaluation by the customer can be further saved.

As described above, when it is determined that the difference between the comprehensive evaluation result and the subjective evaluation result is equal to or higher than the threshold value, the terminal device P1 according to the embodiment calculates the new weighting factors w_{1A} to w_{5A}. As a result, the terminal device P1 according to the embodiment can prevent the increase in the difference between the customer evaluation value (subjective evaluation result) of the actual customer and the comprehensive evaluation value (comprehensive evaluation result). Therefore, the terminal device P1 can further improve the utterance evaluation accuracy of the utterance evaluation of the operator.

As described above, when it is determined that the difference between the comprehensive evaluation result evaluated based on the calculated new weighting factor and the subjective evaluation result is not equal to or less than the threshold value, the terminal device P1 according to the embodiment repeatedly calculates the new weighting factors w_{1A} to w_{5A} until the difference becomes less than the threshold value. As a result, the terminal device P1 according to the embodiment can calculate and set (update) each of the weighting factors w_{1A} to w_{5A} that can prevent the increase in the difference between the customer evaluation value (subjective evaluation result) of the actual customer and the comprehensive evaluation value (comprehensive evaluation result). Therefore, the terminal device P1 can further improve the utterance evaluation accuracy of the utterance evaluation of the operator.

In addition, as described above, the terminal device P1 according to the embodiment stores the comprehensive evaluation results that cause the difference to be equal to or higher than the threshold value, and, when it is determined that the number of the stored comprehensive evaluation results is the predetermined number, the terminal device P1 calculates the new weighting factors w_{1A} to w_{5A} that cause the difference to be less than the threshold value based on each of the predetermined number of the comprehensive evaluation results. As a result, the terminal device P1 according to the embodiment can set the number of the comprehensive evaluation values (comprehensive evaluation results) that serve as the learning data used for machine learning to be the predetermined number or more. That is, the terminal device P1 can calculate each of the new weighting factors w_{1A} to w_{5A} that can further prevent a decrease in utterance evaluation accuracy.

As described above, the number of the comprehensive evaluation results (that is, the predetermined number) stored by the terminal device P1 according to the embodiment in order to calculate the new weighting factors w_{1A} to w_{5A} is equal to the number of the evaluation items. As a result, the terminal device P1 according to the embodiment can learn the weighting factors by using the required number of the comprehensive evaluation values (comprehensive evaluation results) that serve as the learning data used for machine learning, and calculate (update) each of the new weighting factors w_{1A} to w_{5A}.

Although various embodiments have been described above with reference to the drawings, it is needless to say that the present disclosure is not limited to such examples. It will be apparent to those skilled in the art that various modifications, corrections, substitutions, additions, deletions, and equivalents can be conceived within the scope described in the claims, and it is understood that such modifications, corrections, substitutions, additions, deletions, and equivalents naturally belong to the technical scope of the present disclosure. In addition, the respective constituent elements in the various embodiments described above may be combined as desired without departing from the gist of the invention.

The present disclosure is useful as an utterance evaluation method and an utterance evaluation device capable of further improving evaluation accuracy of an utterance evaluation and supporting utterance education for a speaker.

What is claimed is:

1. An utterance evaluation method that evaluates an utterance of a speaker based on a plurality of evaluation items, the utterance evaluation method being performed by a terminal device and comprising:
acquiring utterance voice data of the speaker and a subjective evaluation result provided by a listener;
learning a weighting factor corresponding to each of the plurality of evaluation items based on the subjective evaluation result so as to calculate a new weighting factor; and
evaluating each of the plurality of evaluation items based on the utterance voice data and the calculated new weighting factor and outputting a comprehensive evaluation result of the utterance of the speaker.

2. The utterance evaluation method according to claim 1, wherein the new weighting factor is calculated in a case where it is determined that a difference between the comprehensive evaluation result and the subjective evaluation result is equal to or higher than a threshold value.

3. The utterance evaluation method according to claim 2, wherein, in a case where it is determined that the difference between the comprehensive evaluation result evaluated based on the calculated new weighting factor and the subjective evaluation result is not equal to or less than the threshold value, the calculation of the new weighting factor is repeatedly performed until the difference becomes less than the threshold value.

4. The utterance evaluation method according to claim 2, wherein comprehensive evaluation results that cause the difference to be equal to or higher than the threshold value are stored; and
wherein in a case where it is determined that the number of the stored comprehensive evaluation results is a predetermined number, the new weighting factor that causes the difference to be less than the threshold value is calculated based on each of the comprehensive evaluation results.

5. The utterance evaluation method according to claim 4, wherein the predetermined number is equal to the number of the evaluation items.

6. An utterance evaluation device comprising:
an acquisition unit configured to acquire utterance voice data of a speaker and a subjective evaluation result provided by a listener;
a calculation unit configured to learn a weighting factor corresponding to each of a plurality of evaluation items based on the subjective evaluation result so as to calculate a new weighting factor; and
an output unit configured to evaluate each of the plurality of evaluation items based on the utterance voice data and the calculated new weighting factor and to output a comprehensive evaluation result of an utterance of the speaker.
